(19) United States
(12) Patent Application Publication
(10) Pub. No.: US 2009/0223368 A1
(43) Pub. Date: Sep. 10, 2009

(54) DISTAL HOSE END FILTER

(75) Inventors: Scott D. Augustine, Bloomington, MN (US); Mark C. Albrecht, Minneapolis, MN (US); Keith J. Leland, Medina, MN (US); Randall C. Arnold, Minnetonka, MN (US)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(73) Assignee: AUGUSTINE BIOMEDICAL AND DESIGN, LLC, Eden Prairie, MN (US)

(21) Appl. No.: 12/044,923

(22) Filed: Mar. 7, 2008

(51) Int. Cl. B01D 46/02

(52) U.S. Cl. 95/273; 55/495; 55/497

(57) ABSTRACT

A filter adapted to be placed within a distal end of a hose for use in products such as a convective air warming system for a patient to reduce airborne contamination. A method of providing filtered airflow to a coverlet of a convective air warming system that includes installing a filter in a distal end of a hose of the convective warming system.

### TECHNICAL FIELD

The present invention is related to an air filtration device. More specifically, the present invention relates to a filtration device for a convective air warming system.

### BACKGROUND

The link between airborne contamination and surgical site infection (SSI) has been well established in operating theaters. Airborne contamination consists of all particulate matter suspended in the air; common forms include microbial-laden dust, lint, skin squames, and respiratory droplets. These contaminants are mobilized by air currents and can settle out of the air onto the surgical site. Settled contaminants can contribute to SSI through at least two mechanisms: pathogenic contaminants can be the direct cause of SSI; or non-pathogenic contaminants can enable SSI through the forming of a nidus for pathogen growth and attachment.

Convective patient warming equipment has been identified as both a source and a mobilizer of airborne contamination. Convective patient warming equipment uses an electrically powered blower and heater to supply heated air to an inflatable coverlet that, in turn, distributes the heated air over a patient's body. The proximity of the coverlet to the surgical site necessitates exhausted air be free of contamination. However, the air intake of the blower is often located near the floor of the operating room, a location that is typically laden with high levels of settled and airborne contamination. To lessen the risk of distributing these contaminants, some manufacturers incorporate a filter on the unit's air intake.

As of late, several problems with such intake filtration systems have been identified which can allow viable pathogens to reside within the system and be admitted emitted into the air stream. First, because the intake filter is located on the negative pressure side of the system, contaminants are able to bypass the filter through leaks along the airflow path. Moreover, airborne contamination is generated by moving components within the blower downstream of the filter and emitted into the air stream. In addition, many intake filters comprise a low filtration efficiency media which has been found to provide an inadequate barrier to pathogen ingress. Finally, intake filtration efficiency degrades due to filter media loading and particulate sloughing.

Attempts to improve filtration in convective warming systems have failed to adequately address the problem of pathogen residence and emission from the hose. Moreover, a practical means for retrofitting existing convective warming equipment which has inadequate filtration has not yet been provided.

Thus, a need exists for improved filtering of air flowing through convective patient warming equipment help eliminate viable and non-viable residual airborne contamination in an economical manner. Furthermore, a need exists for existing convective patient warming equipment with inadequate filtration to be retrofitted, in an econmical manner, with the improved filtering capabilities.

### SUMMARY

Some embodiments of the invention include a filter adapted to be placed within a distal end of a hose. The filter comprises a support body and a filter element. The support body is adapted to engage a cross-section of the hose to secure the filter within the hose. The filter element is supported by the support body. In some embodiments, the filter element has a surface area greater than the cross-section of the hose. In some embodiments, the filter element is adapted to be coupled to the support body such that the filter element covers the cross-section of the hose.

Some embodiments of the invention include a filter for a convective patient warm air blanket system that includes a warm air blower and an inflatable patient coverlet, a proximal end of a hose connectable to the blower and a distal end of the hose connectable to the coverlet. The filter may include a support body and a filter element. The support body may be adapted to engage the distal end of the hose and to support the filter element. The filter element has a surface area greater than a cross-section of the hose and is adapted to filter substantially all the air passing from the distal end of the hose.

Some embodiments of the invention include a method of providing filtered airflow to a coverlet of a convective air warming system. The method may include installing a filter in a distal end of a hose of the convective air warming system where the filter includes a filter element coupled about a support body. The method may also include coupling the distal end of the hose to the coverlet causing air to flow within the hose, through the filter, and into the coverlet.

### BRIEF DESCRIPTION OF THE DRAWINGS

The following drawings are illustrative of particular embodiments of the present invention and therefore do not limit the scope of the invention. The drawings are not to scale (unless so stated) and are intended for use in conjunction with the explanations in the following detailed description. Embodiments of the present invention will hereinafter be described in conjunction with the appended drawings, wherein like numerals denote like elements.

FIG. 1 is a plan view of an exemplary convective air warming system.

FIG. 2 is a side-sectional view of a distal end hose connector having a filter according to some embodiments of the invention installed therein.

FIG. 3 is a perspective view of a filter according to some embodiments.

FIG. 4 is a perspective view of a filter according to some embodiments.

FIG. 5 is a perspective view of a filter element according to some embodiments.

FIG. 6 is a bottom plan view of a support body according to some embodiments.

FIG. 7 is a side plan view of a distal hose end having a filter according to some embodiments installed therein.

FIG. 8 is a perspective view of a filter according to some embodiments.

FIG. 9 is a side sectional view of a distal end hose connector having a filter according to some embodiments of the invention installed therein.

FIG. 10 is a side sectional view of a distal end hose connector having a filter according to some embodiments of the invention installed therein.

### DETAILED DESCRIPTION

The following detailed description is exemplary in nature and is not intended to limit the scope, applicability, or configuration of the invention in any way. Rather, the following description provides practical illustrations for implementing exemplary embodiments of the present invention. Those skilled in the art will recognize that many of the examples provided have suitable alternatives that can be utilized. For purposes of this specification and its claims, the term “hose” should be read to include all portions of a hose and any connectors or extenders located at the distal or proximal ends of the hose, even when such connectors are separately and explicitly described. For example, a groove “within a distal hose end connector attached to a hose,” should be considered “within the hose” as well as “within the distal end connector.”

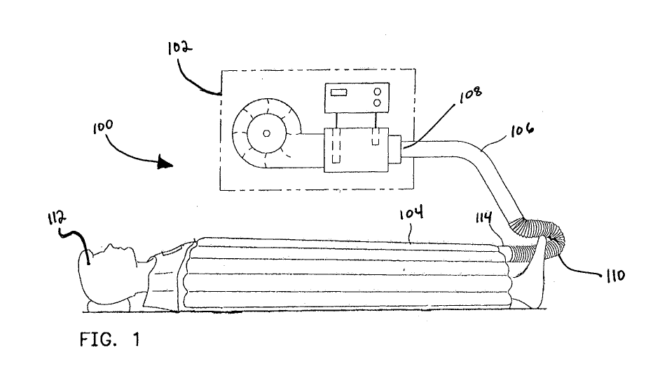

With reference to FIG. 1, there is shown an exemplary convective air warming system 100 typical of a warming system commonly used in a medical setting. Such systems generally include a heater/blower unit 102 coupled in air flow communication with a coverlet 104 by a hose 106. The hose 106 includes a proximal end 108 coupled to the heater/blower unit 102 and a distal end 110 coupled to the coverlet 104. As shown, the coverlet 104 can be draped or otherwise positioned on a patient 112 so as to disperse the warm air delivered by the heater/blower unit 102 over desired surfaces of the patient 112. Generally, the coverlet 104 is a disposable item to be discarded after each use to prevent the passing of contaminants between successive patients. The heater/blower unit 102 and hose 106, however, are reusable. In view of this, the distal end 110 of the hose 106 includes a distal hose end connector 114 which can easily be inserted and removed from the coverlet 104 at a hose access point to facilitate swapping out of coverlets.

Certain embodiments of the invention provide a filter adapted to be placed within the distal end 110 of a hose 106, such as that of FIG. 1. By providing a filter within the distal hose end 110 of the convective air warming system 100, the invention removes contaminants present in the air stream immediately prior to air delivery from the hose 106. Moreover, it does so without having to provide a large filter surface area in a disposable product, such as the coverlet. In this manner, embodiments of the invention can be used to retro-fit systems currently in use with improved filtration capabilities at a low cost.

FIG. 2 depicts an embodiment of a filter 200 including a support body 202 and a filter element 204 according to one embodiment installed within a distal hose end connector 114 attached to a hose 106. The pictured embodiment can be described as a “negative” filter, because the filter element 204 extends proximally within the hose 106, rather than protruding out of the distal hose opening 206 or residing on the exterior of the hose 106. In some embodiments, the support body 202 can be a wire or molded plastic piece adapted to perform two functions: to secure the filter 200 to the inside of the distal hose end 106; and, to support the filter element 204 in a shape that maximizes filter media surface area and thus minimizes the pressure drop across the filter element 204. To secure the filter 200 to the inside of the hose 106, the support body 202 includes a base 208. In some embodiments, the base 208 can be used to take advantage of an internal groove 210 within the hose connector 114 located between the connector housing 212 and locking piece 214. Base 208 of the support body 202 can be inserted to reside within this groove 210, thereby providing a secure placement of the filter 200 within the hose 106.

To minimize the pressure drop across the filter element 204, support body 202 can maintain the filter element 204 in a shape that maximizes active filter media surface area and minimizes filter face air velocity. The combination of airflow rates and distal end hose diameters used in convective patient warming equipment result in un-favorable conditions for the use of an in-line filter element oriented perpendicular to the direction of bulk airflow 216. Such a combination could result in excessive pressure drops for even low efficiency filtration media. For higher efficiency filtration media, this problem would only be exacerbated. To solve this problem, certain embodiments of the invention present the filter element 204 oriented at an angle relative to the direction of bulk airflow 216. For example, in the embodiment of FIG. 2 the filter element 204 is generally conical. Filter element support portion 218 of the support body 202 provides support to the filter element 204 allowing it to maintain this generally conical shape despite the air pressure exerted by the bulk airflow 216 against the proximal end.

Increasing the surface area of the filter element 204 not only reduces the pressure drop across the filter 200, but also enables the use of high efficiency filtration media. Thus, some preferred embodiments include a high efficiency depth type filtration media. A depth type media can provide several advantages over a membrane type filtration media. Notably, depth type filter media can provide increased particulate removal efficiency and increased dirt-holding capability at a lower cost than membrane type filters. However, this is not to say that membrane or other types of filtration media are excluded from the scope of the invention. To the contrary, some embodiments include a filter element comprised of such filtration types.

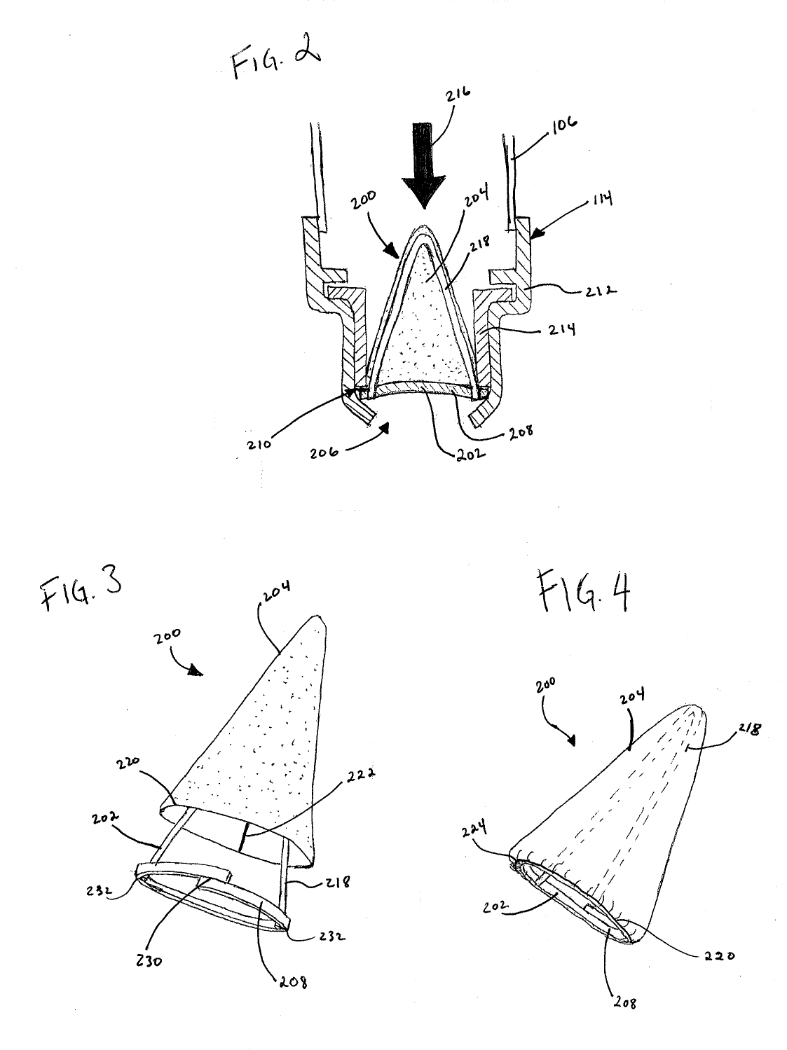

FIG. 3 depicts a perspective view of an embodiment of a filter 200 such as that of FIG. 2. In this view, the filter element 204 has been partially removed from its installed position to reveal features of the support body 202. In an installed configuration (see e.g. FIG. 4), the distal end 220 of the filter element 204 would be pulled down to the base 208 of the support body 202 to completely enclose a generally conical volume defined by the filter element 204 and the base 208. Such a filter 200 may then be inserted within a distal hose end to provide filtering of air passing through the hose. This view illustrates, that in some embodiments, the filter element 204 can be a disposable component of the device. Disposable filter elements 200 can increase the economic efficiency of the device by providing for replacement of only the filter element 204 portion of the filter and reuse of the support body.

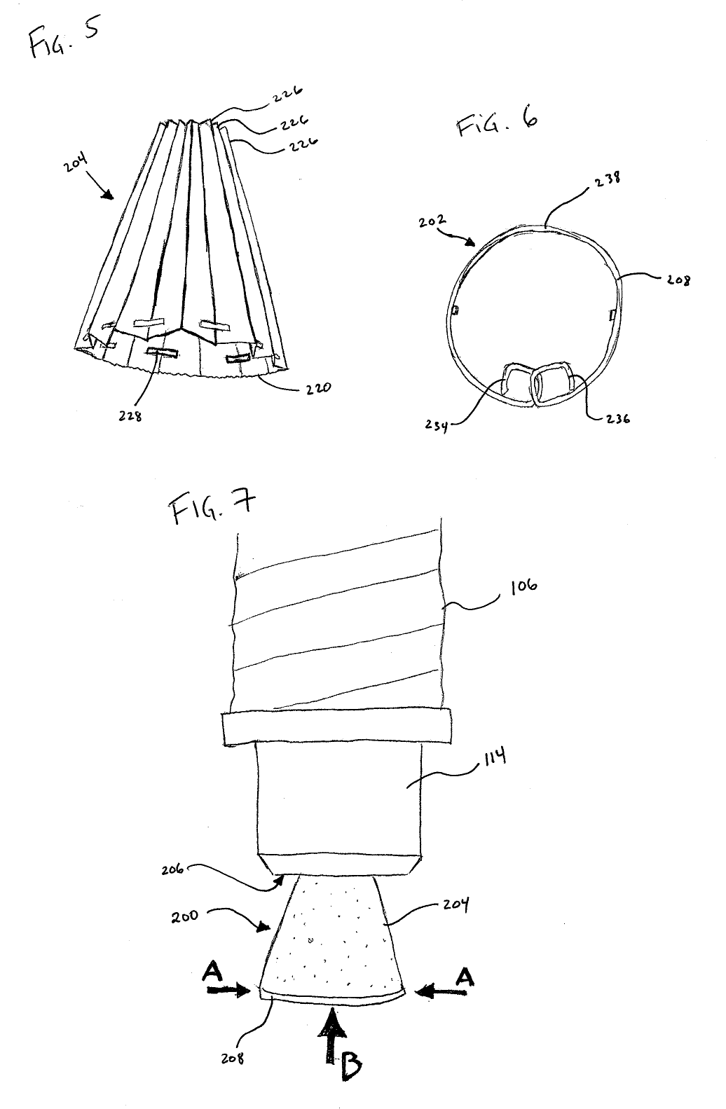

Although, as discussed above, a range of filter element 204 designs and construction techniques are within the scope of the invention, embodiments that form a sock-like shape may have certain ease of use and cost saving advantages. For example, the conical filter element 204 of FIGS. 3 and 4 can comprise flexible, or semi-rigid filter media die cut from a sheet and joined at a seam 222 by heat seal, adhesive, sewing, or other connection means. In some embodiments, a preferred material for a filter media of this arrangement is Technostat® available from Hollingsworth & Vose Company of East Walpole, Mass. Moreover, in some embodiments, the filter element 204 can include an elastic band 224 or other attachment mechanism at its distal end 220. This attachment mechanism can secure the filter element 204 to the support body 202 by, for example, cinching the distal end 220 about the base 208 as in FIG. 4. Other examples of an attachment mechanism can include snaps, hook-and-loop connector systems, adhesives, pins, staples, and any other suitable connector. Another embodiment of a filter element 204 is shown in FIG. 5. In this embodiment, the filter element 204 is generally conical having a plurality of pleats 226 about the surface of the filter media. Pleats 226 can be incorporated into a filter element of any shape and can provide an increased filter media surface area to increase filtration efficiency. Additionally, the embodiment of FIG. 5 shows a string 228 passing through the filter media around the distal end 220. String 228 represents yet another example of an attachment mechanism and can be drawn tight to secure the filter element 204 about a support body.

Referring back to FIG. 3, support body 202 can comprise numerous variations. In many embodiments, the support body 202 includes a base 208 and a filter element support portion 218. The base 208 can be generally ring-shaped and can be adapted to engage a cross-section of a hose. As described above, the base 208 can be adapted to fit within a groove in a distal hose end connector or some other portion of the hose. Alternatively, for example, the base can be sized slightly larger than the cross-section of hose such that when the support body is inserted therein, it exerts pressure radially outward toward the hose wall, thereby frictionally engaging the hose. In other embodiments, a hose engaging mechanism may extend from the base to couple with the hose or receiving mechanisms placed thereon. In still further embodiments, the base may not be ring-shaped, but can instead be semi-circular, squared, or otherwise shaped. In the embodiment of FIG. 3, base 208 is a coil of metal wire, having an overlap portion 230. A coiled base can provide for compressibility of the base which can facilitate insertion into the hose. In other embodiments, the base may be a solid ring made of a molded plastic, metal, rubber, or other suitable material. In a preferred embodiment, the base is made of spring steel wire of a diameter of about 0.100 inches formed into a coiled ring having a diameter of approximately 1.5-2.5 inches. It should be apparent that the design of the support body 202 and its attachment features allow for easy placement of the filter 200 into nearly all distal hose end designs currently in clinical use. As such, embodiments of the invention can provide an easy and reliable means for retrofitting existing convective patent warming equipment with adequate filtration.

The support body 202 of FIG. 3 further includes a filter element support portion 218 coupled to the base 208. As described above, because negative filters extend proximally within the hose in opposition to the direction of bulk airflow, support may need to be provided to the filter element to keep it from collapsing due to airflow pressure. In this embodiment, the filter element support 218 is a rigid, inverse “V”-shaped wire, coupled to the base 208 at attachment points 232. In large part, the design of the filter element support portion 218 depends on the shape of the filter element 204 being used. An inverse “V” shape is appropriate for use with a conical filter element 204 because this shape provides lateral support to the conical surface from base to peak with minimal obstruction of airflow through the filter 200. Many other designs too numerous to mention can provide similar and adequate functionality to the “V” shaped exemplary embodiment pictured and such other designs may vary depending upon the type of filter element used. Attaching the filter element support portion 218 can be accomplished by any suitable means such as, for example, welding, adhesive bonding, stapling, or other attachment mechanisms. In some embodiments, the filter element support portion 218 and base 208 can comprise one solid piece, such as for example, a single molded piece of plastic, or a single bent wire.

In many applications, the distal end of a hose used in convective air warming systems must be flexible. Often, due to the positioning of the coverlet and its air inlet, the hose must be able to make a sharp bend within 6 inches of the distal end. To accommodate this flexibility, many embodiments of the distal hose end filter 200 include a flexible filter element 204 and filter element support portion 218. For example, a negative filter may include a “V”-shaped filter element support portion comprising a flexible metal wire, such as for example spring steel, so that the point of the “V” may flex out of plane.

In some embodiments, the support body 202 can include a deformation mechanism to aid in temporarily deforming at least a portion of the support body to facilitate insertion of the filter into a hose. For example, FIG. 6 shows a bottom plan view of a support body 202 including a deformation mechanism according to some embodiments. Here, the metal wire comprising the base 208 has been bent three times near each end to provide first and second handles 234, 236. A user installing the support body 202 within a hose, can apply pressure at each handle 234, 235 causing the first handle 234 to move toward the second handle 236 and the base 208 to flex about a flex point 238 generally opposite the handles 234, 236. This flexing causes the diameter of the base 208 to compress to a suitable diameter for insertion into a hose. One having ordinary skill in the art can appreciate many variations of the described deformation mechanism. For example, a separate handle piece could be welded or otherwise attached to the base to provide a grip for compressing the diameter of the support body. Alternatively, the filter element support portion can, in some embodiments, include attached squeeze points or be used as squeeze points for temporarily deforming the support body. Moreover, a deformation mechanism can extend from the support body in any direction and need not reside within the plane of the base as shown in the embodiment of FIG. 6.

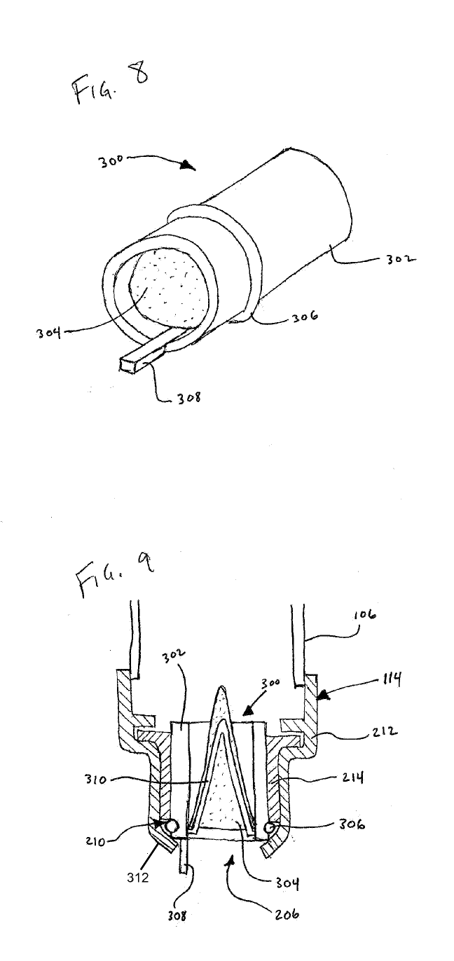

FIG. 7 shows how a filter 200 may be installed according to embodiments of the invention. Here, a hose 106 having a distal end connector 114 is shown. A filter 200 according to one embodiment, is being inserted into the distal opening 206 of the hose 106 in a negative orientation, i.e. so that the filter element 204 remains entirely within the hose 106. In many embodiments the base 208 of the filter 200 is slightly larger than the distal opening 206 to allow the filter 200 to be secured within the hose 106 as discussed above. To fit the wider base 208 past the narrower distal opening 206, a user can first compress the base 208 of this embodiment by squeezing according to arrows A. Other filter embodiments may be sized so that no compression is necessary, or may include another deformation mechanism (e.g. the handles 234, 236 of FIG. 6). The filter 200 can then be inserted into position within the hose according to arrow B, for example to the position shown in FIG. 2.

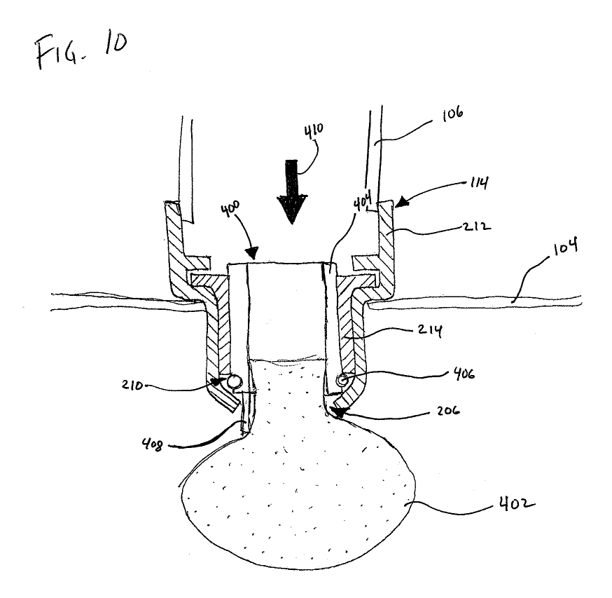

In an alternative embodiment, which can be seen by reference to FIGS. 8 and 9, the filter 300 comprises a tubular support body 302 having a filter element 304 disposed within. Tubular support body 302 can include a snap ring 306 for securing the filter 300 within the hose 106, for example in the groove 210 defined by the locking piece 214 and connector housing 212 of a distal hose end connector 114. A removal tab 308 or other removal mechanism can be coupled to the snap ring 306. In one embodiment, the removal tab 308 can provide a means for the user to grip the tubular support body and facilitate removal through allowing the application of sufficient force to expand the distal hose end lip 312 by contact with the groove 210. In another embodiment, pressing upon the removal tab 308 can provide at least partial retraction of the snap ring 306 within the support body 302, thereby allowing an installed filter 300 to slide through the distal hose opening 206 and be removed from the hose 106. In such embodiments, the support body 302 can comprise a generally rigid molded plastic or metal tube. A filter element 304 such as one of those described above, may be fixedly coupled to the support body 302 by any suitable means, such as for example, adhesive bonding. Some embodiments further include a filter element support portion 310 within the support body 302 distally positioned relative to the filter element 304. A filter element support portion 310 can be functionally and structurally similar to the filter element support portion discussed above in reference to other embodiments. Here, the filter element support portion 310 can comprise a metal wire or other component installed within the tubular support body 302, or may comprise a molded plastic formed in the same process used to mold the support body.

In yet another embodiment, a filter 400 according to the invention can include a filter element 402 configured to protrude from the distal hose opening 206. Such an embodiment can be seen in FIG. 10. Embodiments including a “positive” filter element 402 can include a support body 404 having a filter element 402 permanently attached thereto. The support body 404 can be of any construction and include variations according to the support body designs discussed above. For example, a suitable support body may comprise a metal wire ring such as the base 208 of support body 202 in FIG. 3. The embodiment of FIG. 10 depicts a filter 400 including a tubular support body 404 similar to that of FIG. 8. Tubular support body 404 can comprise a molded plastic and include a snap ring 406 and removal tab 408 for locking the filter 400 in place within a hose, for example in the groove 210 defined by the locking piece 214 and connector housing 212 of a distal hose end connector 114.

Filter element 402 can comprise a high efficiency depth filter material as described above. In a positive filter arrangement however, the filter surface area is not maximized by maintaining the filter in a particular arrangement. Rather, the filter element 402 is designed to expand under the pressure of bulk airflow 410. To this end, a pliable filter element material is desirable because a rigid filter element may not expand properly to present an appropriately sized filter surface area. In use, an appropriately expanded filter element 402 presents a filter element 402 having an inflated shape external of the hose 106. This inflated shape can assume any number of designs, for example, a bulb shape (as seen in FIG. 10), a skirt shape, a “T”-shape, or any number of other designs, each providing a large filter media surface area through which airflow 410 from the hose 106 must pass before entering the coverlet 104. Prior to installation in a hose, the filter element 402 can be balled-up, folded, wound, or otherwise stowed within the support body 404 so the filter element 402 is not torn or damaged. Pressure from bulk air flow 410 can cause a stowed filter element 402 to expand to the inflated configuration seen in FIG. 10. Following use, the filter 400 may be disposed of with the coverlet 104, or may be reused.

In the foregoing detailed description, the invention has been described with reference to specific embodiments. However, it may be appreciated that various modifications and changes can be made without departing from the scope of the invention.

What is claimed is:

1. A filter adapted to be placed within a distal end of a hose, the filter comprising:
a support body adapted to engage a cross-section of the hose thereby securing the filter within the hose; and
a filter element supported by the support body, having a surface area greater than the cross-section of the hose, and adapted to be coupled to the support body such that the filter element covers the cross-section.

2. The filter of claim 1, wherein the support body includes a base which is adapted to engage the cross-section of the hose and a filter element support portion protruding from the base, the filter element support portion adapted to support the filter element within the hose in a negative orientation.

3. The filter of claim 2, wherein the base is generally ring-shaped.

4. The filter of claim 1, wherein the support body comprises a generally tubular body having a snap ring about a circumference of the generally tubular body, the snap ring adapted to fit within a groove about the cross-section of the hose, thereby securing the filter within the hose.

5. The filter of claim 1, wherein the filter element comprises a depth filter media.

6. The filter of claim 1, wherein the filter element is generally conical.

7. The filter of claim 1, wherein the filter element is disposable and can be removably coupled to the support body.

8. The filter of claim 7, wherein the filter element includes an elastic band for removably coupling the filter element to the support body.

9. The filter of claim 1, wherein the filter element includes pleats.

10. The filter of claim 1, wherein the support body includes a deformation mechanism for temporarily deforming at least a portion of the support body for insertion into the hose.

11. The filter of claim 1, wherein the support body comprises a metal frame.

12. The filter of claim 11, wherein the support body comprises spring steel.

13. The filter of claim 1, wherein the support body comprises plastic.

14. The filter of claim 1, wherein the the hose is adapted for use with a convective air warming system.

15. The filter of claim 1, wherein the filter element comprises an expandable filter, configured to expand under pressure from a bulk airflow passing through the hose.

16. The filter of claim 15, wherein the expandable filter is permanently coupled to the support body.

17. The filter of claim 15, wherein the expandable filter is adapted to protrude from the distal end of the hose and assume an inflated shape, the surface area of the filter element in the inflated shape being greater than the cross-section of the hose.

18. The filter of claim 17, wherein the inflated shape comprises a bulb shape.

19. The filter of claim 17, wherein the inflated shape comprises a “T”-shape.

20. A filter for a convective patient warm air blanket system that includes a warm air blower and an inflatable patient coverlet, a proximal end of a hose connectable to the blower and a distal end of the hose connectable to the coverlet, the filter comprising:
a support body adapted to engage the distal end of the hose;
a filter element supported by the support body and having a surface area greater than a cross-section of the hose, the filter element filtering substantially all the air passing from the distal end of the hose.

21. A method of providing filtered airflow to a coverlet of a convective air warming system comprising:
installing a filter in a distal end of a hose of the convective air warming system, the filter comprising a filter element coupled about a support body;
coupling the distal end of the hose to the coverlet; and
causing air to flow within the hose, through the filter, and into the coverlet.

22. The method of claim 21 wherein the step of installing the filter further comprises:
installing the filter element about a filter element support portion of the support body;
compressing the support body such that the support body becomes small enough to fit through a distal end opening of the hose;
inserting the filter through the distal end opening, and into position proximate a cross-section of the hose; and
uncompressing the support body causing the support body to expand and a base of the support body to engage the cross-section of the hose.
